(19) United States
(12) Patent Application Publication
(10) Pub. No.: US 2025/0069494 A1
(43) Pub. Date: Feb. 27, 2025

(54) STATE ESTIMATION DEVICE, STATE ESTIMATION METHOD, AND COMPUTER-READABLE STORAGE MEDIUM

(71) Applicant: NEC Corporation, Minato-ku, Tokyo (JP)

(72) Inventors: Takeshi HISHIYAMA, Tokyo (JP); Tetsuhiro TSUNODA, Tokyo (JP); Toshihiro ENDO, Tokyo (JP)

(73) Assignee: NEC Corporation, Minato-ku, Tokyo (JP)

(21) Appl. No.: 18/724,662

(22) PCT Filed: Mar. 11, 2022
(86) PCT No.: PCT/JP2022/010945

§ 371 Date: Jun. 27, 2024

(51) Int. Cl. G08B 27/00; H04W 4/90

(52) U.S. Cl. CPC G08B 27/001; H04W 4/90

(57) ABSTRACT

One of the purposes of the present invention is to provide a state estimation device, etc. that make it possible to support the suitable issuance of instructions to subjects. A state estimation device according to an aspect of the present invention is provided with: an acquisition means for acquiring position information of a plurality of subjects, as well as behavior information, which relate to behavior measured in relation to the subjects; an estimation means for estimating individual activity states of the subjects on the basis of the behavior information; and an output control means for outputting subject information, which represents the position information and the activity states for the individual subjects.

### TECHNICAL FIELD

The present disclosure relates to a technology of issuing an instruction to a subject such as a police officer.

### BACKGROUND ART

In a case where an incident, an accident, or the like has occurred, for example, a police station, a fire department, or the like is notified according to a situation. An operator of an instruction room who has received the notification issues an instruction to a police officer, a fire brigade, an ambulance team, and the like, who are to arrive at a site, according to the notification content.

In relation to the instruction to the police officer, PTL 1 discloses a technology related to a portable communicator for police that assists an activity of the police officer. Specifically, PTL 1 discloses that the portable communicator notifies a police department of position coordinate data of a current position of the police officer, and the police department transmits an instruction according to the position.

### CITATION LIST

### Patent Literature

PTL 1: JP 2010-119118 A

### SUMMARY OF INVENTION

### Technical Problem

It is assumed that an event such as an incident and an accident occurs, and an instruction is sent from an instruction room to a subject such as a police officer, a fire brigade, and an ambulance team. However, when the subject who has received the instruction is in the middle of responding to another task, there is a possibility that the subject cannot respond to the instruction quickly. Then, there is a risk that handling of the occurring event is delayed.

The present disclosure has been made in view of the above problems, and an object of the present disclosure is to provide a state estimation device and the like that make it possible to support suitable issuance of instructions to subjects.

### Solution to Problem

A state estimation device according to an aspect of the present disclosure includes: an acquisition means for acquiring position information of a plurality of subjects and behavior information that is information relating to behaviors measured with respect to the subjects: an estimation means for estimating an activity state of each of the subjects based on the behavior information; and an output control means for outputting subject information that is information showing the position information and the activity state for each of the subjects.

A state estimation method according to an aspect of the present disclosure includes: acquiring position information of a plurality of subjects and behavior information that is information relating to behaviors measured with respect to the subject: estimating an activity state of each of the subjects based on the behavior information; and outputting subject information that is information showing the position information and the activity state for each of the subjects.

A computer-readable storage medium according to an aspect of the present disclosure has stored therein a program that causes a computer to execute: a process of acquiring position information of a plurality of subjects and behavior information that is information relating to behaviors measured with respect to the subject: a process of estimating an activity state of each of the subjects based on the behavior information; and a process of outputting subject information that is information showing the position information and the activity state for each of the subjects.

### Advantageous Effects of Invention

According to the present disclosure, it is possible to support suitable issuance of instructions to subjects.

### BRIEF DESCRIPTION OF DRAWINGS

FIG. 1 is a block diagram illustrating an example of a functional configuration of a state estimation device according to a first example embodiment of the present disclosure.

FIG. 2 is a flowchart illustrating an example of an operation of the state estimation device according to the first example embodiment of the present disclosure.

FIG. 3 is a diagram schematically illustrating an example of a configuration including a state estimation device according to a second example embodiment of the present disclosure.

FIG. 4 is a block diagram illustrating an example of a functional configuration of the state estimation device according to the second example embodiment of the present disclosure.

FIG. 5 is a diagram illustrating an example of subject information according to the second example embodiment of the present disclosure.

FIG. 6 is a diagram illustrating another example of the subject information according to the second example embodiment of the present disclosure.

FIG. 7 is a flowchart illustrating an example of an operation of the state estimation device according to the second example embodiment of the present disclosure.

FIG. 8 is a block diagram illustrating an example of a functional configuration of a state estimation device according to a third example embodiment of the present disclosure.

FIG. 9 is a diagram illustrating an example of subject information according to the third example embodiment of the present disclosure.

FIG. 10 is a flowchart illustrating an example of an operation of the state estimation device according to the third example embodiment of the present disclosure.

FIG. 11 is a block diagram illustrating an example of a functional configuration of a state estimation device according to a fourth example embodiment of the present disclosure.

FIG. 12 is a diagram illustrating a display example of a communication terminal according to the fourth example embodiment of the present disclosure.

FIG. 13 is a flowchart illustrating an example of an operation of the state estimation device according to the fourth example embodiment of the present disclosure.

FIG. 14 is a block diagram illustrating an example of a hardware configuration of a computer device which achieves the state estimation devices according to the first, second, third, and fourth example embodiments of the present disclosure.

### EXAMPLE EMBODIMENT

Hereinafter, example embodiments of the present disclosure will be described with reference to the drawings.

### First Example Embodiment

An outline of a state estimation device of the present disclosure will be described.

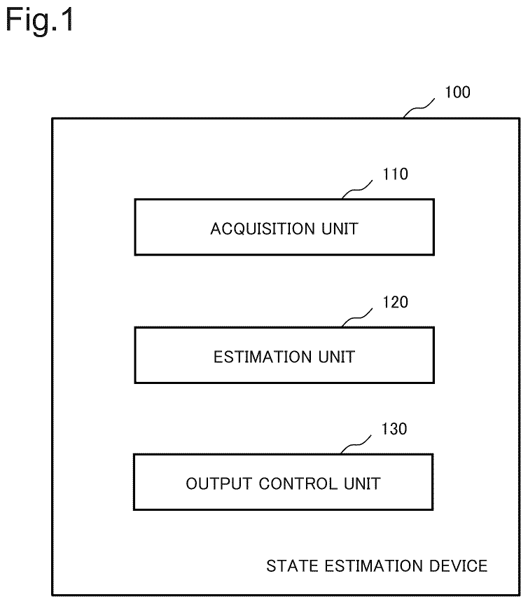

FIG. 1 is a block diagram illustrating an example of a functional configuration of a state estimation device 100. The state estimation device 100 is a device that can be connected in a wired or wireless communicable manner to a device possessed by a subject and a device that measures a behavior of the subject which will be described later.

For example, in a case where an event such as an incident or an accident has occurred, an instruction system of an instruction room receives notification. The instruction room indicates an organization that issues instructions to subjects such as a police officer, a fire brigade, and an ambulance team according to the content of the notification. The subject indicates a person who is to act in response to the instruction. For example, an operator of the instruction room issues, to the subject, an instruction indicating deployment to a place where an incident or an accident has occurred. The state estimation device 100 of the present disclosure is used in such a situation where an instruction is issued to the subject, as an example.

As illustrated in FIG. 1, the state estimation device 100 includes an acquisition unit 110, an estimation unit 120, and an output control unit 130.

The acquisition unit 110 acquires position information of a plurality of subjects. For example, the acquisition unit 110 acquires the position information from a device possessed by the subject. The device possessed by the subject is a device capable of acquiring positioning information that is information obtained by measuring a point where the device is positioned. The acquisition unit 110 acquires, for example, the positioning information as the position information of the subject.

In addition, the acquisition unit 110 also acquires behavior information. The behavior information is information relating to a behavior measured for the subject. The behavior information may be data measured by a sensor attached to the subject. For example, in a case where a microphone is attached to the subject, the behavior information includes voice data relating to a voice uttered by the subject. In addition, for example, in a case where an acceleration sensor, a gyro sensor, or the like is attached to the subject, the behavior information includes motion data of the subject. For example, the acquisition unit 110 may acquire, as the behavior information of the subject, data measured by the sensor. Note that the behavior information is not limited to this example. The behavior information may further include different data or may include a plurality of types of data.

In this manner, the acquisition unit 110 acquires the position information of the plurality of subjects and the behavior information that is the information relating to the behaviors measured for the subjects. The acquisition unit 110 is an example of the acquisition means.

The estimation unit 120 estimates each activity state of the subject. The activity state is information indicating the status of the subject. The activity state may be, for example, information indicating whether the subject is being engaged, or information indicating busyness of the subject. That is, the activity state is an index indicating whether the subject can respond to an instruction. In the present disclosure, a state where it is difficult to respond to an instruction is referred to as a busy state. In addition, a state where it is possible to respond to an instruction is referred to as a free state.

The estimation unit 120 estimates the activity state based on the behavior information. For example, the estimation unit 120 may estimate, based on the behavior information, that the subject is in the busy state in a case where the subject frequently moves. Then, in a case where the time during which the subject is stationary is long, the estimation unit 120 may estimate that the subject is in the free state. In addition, for example, the estimation unit 120 may estimate, based on the behavior information, that the subject is in the busy state in a case where the subject speaks at a certain frequency or more. Then, the estimation unit 120 may estimate that the subject is in the free state in a case where the frequency of speaking of the subject is less than a predetermined value. Note that a method for estimating the activity state is not limited to this example.

In this manner, the estimation unit 120 estimates each activity state of the subject based on the behavior information. The estimation unit 120 is an example of the estimation means.

The output control unit 130 outputs the subject information. The subject information is information showing the position information and the activity state for each subject. For example, the output control unit 130 associates the position information and the activity state corresponding to each subject. Then, the output control unit 130 outputs, as the subject information, information in which the position information and the activity state are associated with each other for each subject. At this time, the output control unit 130 may further associate attribute information indicating the attribute of the subject. The output control unit 130 displays the subject information on a display device, for example. The display device may be, for example, a display or the like that can be visually recognized by an operator of the instruction room.

In this manner, the output control unit 130 outputs the subject information showing the position information and the activity state for each subject. The output control unit 130 is an example of the output control means.

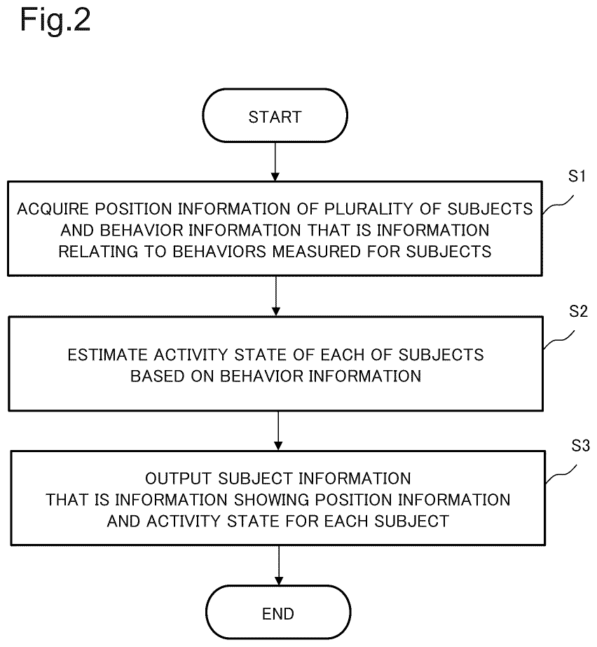

Next, an example of an operation of the state estimation device 100 will be described with reference to FIG. 2. Note that in the present disclosure, each step of a flowchart is expressed by using a number, such as “S1”, which is assigned to each step.

FIG. 2 is a flowchart illustrating an example of the operation of the state estimation device 100. The acquisition unit 110 acquires position information of a plurality of subjects and behavior information that is information relating to behaviors measured for the subjects (S1). The estimation unit 120 estimates the activity state of each of the subjects based on the behavior information (S2). The output control unit 130 outputs subject information showing the position information and the activity state for each subject (S3).

In this manner, the state estimation device 100 according to the first example embodiment acquires the position information of the plurality of subjects and the behavior information that is the information relating to the behaviors measured for the subjects. In addition, the state estimation device 100 estimates the activity state of each of the subjects based on the behavior information. Then, the state estimation device 100 outputs the subject information that is information showing the position information and the activity state for each subject. For example, it is assumed that an operator of the instruction room issues an instruction to the subject when an event such as an incident or an accident has occurred. The state estimation device 100 can output the position information and activity states of the plurality of subjects. Accordingly, for example, the operator of the instruction room can grasp the subject who can respond to the instruction by checking the position information and the activity state of each of the subjects. Therefore, for example, the operator of the instruction room can send an instruction to a subject who can respond to the instruction, so that the occurring event can be handled more quickly. Therefore, the state estimation device 100 can support the suitable issuance of the instruction to the subject.

### Second Example Embodiment

Next, a state estimation device according to a second example embodiment will be described. In the second example embodiment, the state estimation device 100 described in the first example embodiment will be described in more detail. Note that description of contents overlapping with the contents described in the first example embodiment will be partially omitted.

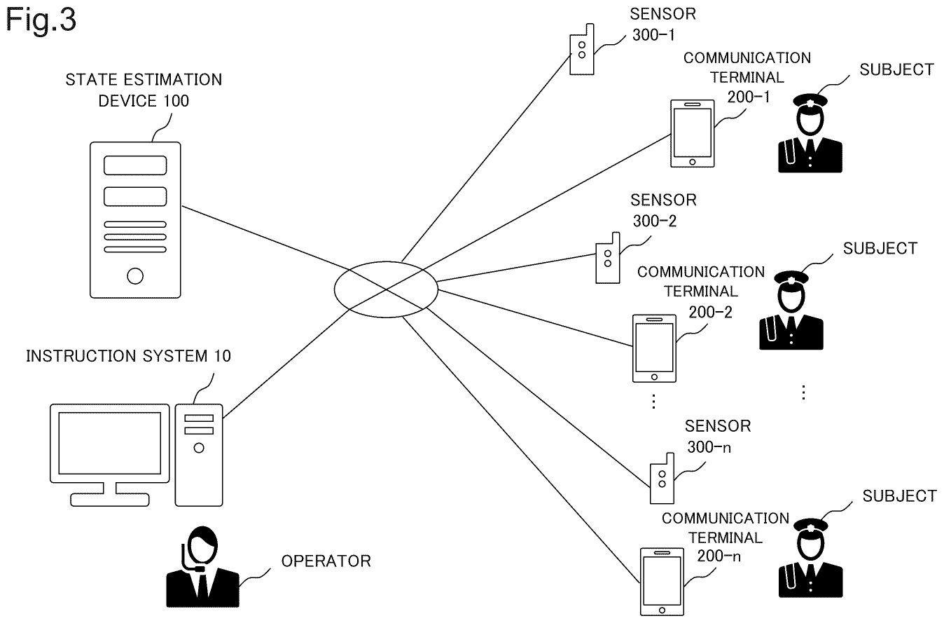

FIG. 3 is a diagram schematically illustrating an example of a configuration including the state estimation device 100. As illustrated in FIG. 3, the state estimation device 100 is communicably connected to the instruction system 10 of the instruction room via a wireless or wired network. In addition, the state estimation device 100 is communicably connected to communication terminals 200-1, 200-2, . . . , and 200-n (n is a natural number) and sensors 300-1, 300-2, . . . , and 300-n via a wireless or wired network. Here, in a case where the communication terminals 200-1, 200-2, . . . , and 200-n are not distinguished from one another, the communication terminals 200-1, 200-2, . . . , and 200-n are simply referred to as communication terminals 200. In addition, in a case where the sensors 300-1, 300-2, . . . , and 300-n are not distinguished from one another, the sensors 300-1, 300-2, . . . , and 300-n are simply referred to as sensors 300. Note that a configuration including the state estimation device 100, the communication terminal 200, and the sensor 300 may be achieved as a state estimation system.

The instruction system 10 is a system provided in the instruction room. For example, in a case where an event such as an incident or an accident has occurred, notification is performed by a notifier. At this time, the notifier may be a general citizen or a subject. The instruction system 10 receives the notification. The operator of the instruction room makes a call with the notifier via the instruction system 10, for example. That is, the instruction system 10 may include, for example, a function capable of achieving a call between the operator of the instruction room and the notifier. In addition, for example, the operator of the instruction room may issue an instruction to the subject by using the instruction system 10. That is, the instruction system 10 may have a function of notifying the subject of the instruction. Note that the state estimation device 100 may be a device included in the instruction system 10.

The communication terminal 200 is an example of the device possessed by the subject. The communication terminal 200 is, for example, a portable terminal such as a mobile phone, a smartphone, and a tablet terminal. Note that the communication terminal 200 is not limited to this example. The communication terminal 200 may be a personal computer. The communication terminal 200 may be a device including a plurality of devices. It is sufficient if the communication terminal 200 has a function of acquiring the positioning information that is information obtained by measuring at least a point where the communication terminal is positioned. Here, the positioning information may be, for example, information measured by a global navigation satellite system (GNSS) such as a global positioning system (GPS).

The communication terminal 200 acquires the positioning information obtained by measurement using, for example, the GNSS. Then, the communication terminal 200 transmits the positioning information to the state estimation device 100. At this time, the communication terminal 200 may transmit, to the state estimation device 100, the positioning information and the identification information of the subject who is the possessor of the communication terminal 200.

For example, in a case where the subject is a police officer, the communication terminal 200 may be a device mounted on a patrol car. In addition, in a case where the subject is a fire brigade, the communication terminal 200 may be a device mounted on a fire vehicle. In addition, in a case where the subject is an ambulance team, the communication terminal 200 may be a device mounted on an ambulance. In this manner, the communication terminal 200 may be a device mounted on a vehicle on which the subject rides.

In the present example embodiment, it is assumed that each of the subjects possesses one communication terminal 200. Note that each of the subjects may possess a plurality of communication terminals 200.

The sensor 300 is an example of the device attached to the subject. Here, “attached to the subject” includes being attached to the body or clothing of the subject and being possessed by the subject. The sensor 300 is a device capable of measuring information relating to the behavior of the subject. The sensor 300 is, for example, various sensors such as a microphone, an acceleration sensor, a gyro sensor, and a geomagnetic sensor. In addition, the sensor 300 may be a sensor obtained by combining various sensors. The sensor 300 may be a wearable terminal. That is, the sensor 300 may be a device that can be worn or carried by the subject. In addition, the sensor 300 and the communication terminal 200 may be an integrated device.

The sensor 300 measures, for example, a voice of the subject. In this case, the sensor 300 capable of measuring a voice such as a microphone is attached to the clothing of the subject, for example. Then, the sensor 300 generates voice data indicating the measured voice.

In addition, for example, the sensor 300 measures the motion of the subject. Then, the sensor 300 generates motion data of the subject based on the result of the motion measurement. Here, an example of the motion data is gait data. The gait indicates a walking manner of an animal including a human. The gait includes, for example, a stride length, a speed, a walking rhythm, a traveling direction, an angle of a foot, an angle of a waist, and the like of a human. In this case, the sensor 300 capable of measuring the gait is attached to, for example, the insole of the shoe of the subject. Then, the sensor 300 generates gait data by measuring a temporal change in the load from the sole of the subject.

The sensor 300 transmits the measured data to the state estimation device 100. At this time, the sensor 300 may transmit, to the state estimation device 100, the measured data and the identification information of the subject to which the sensor 300 is attached.

In the present example embodiment, an example in which the communication terminal 200 and the sensor 300 are separate devices will be mainly described. In addition, the present example embodiment will be described on the premise that at least one or more sensors 300 are attached to each of the subjects.

### [Details of State Estimation Device 100]

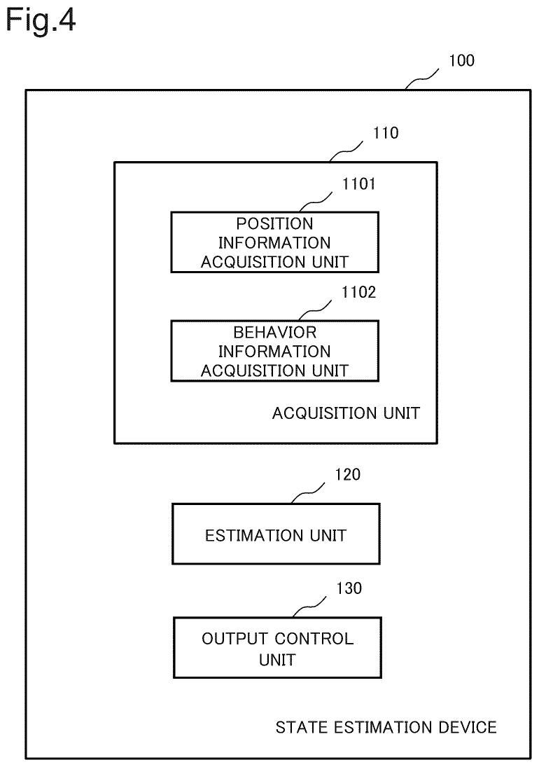

FIG. 4 is a block diagram illustrating an example of a functional configuration of the state estimation device 100. As illustrated in FIG. 4, the state estimation device 100 includes the acquisition unit 110, the estimation unit 120, and the output control unit 130.

The acquisition unit 110 includes a position information acquisition unit 1101 and a behavior information acquisition unit 1102. The position information acquisition unit 1101 acquires the position information of each subject. Specifically, the position information acquisition unit 1101 acquires positioning information from the communication terminal 200 possessed by each subject. The position information acquisition unit 1101 acquires position information based on the positioning information. The position information may be information indicating coordinates such as a latitude and a longitude, or may be information indicating an address.

The behavior information acquisition unit 1102 acquires the behavior information of each subject. Specifically, the behavior information acquisition unit 1102 acquires the data measured by the sensor 300 from the sensor 300. The measured data may be at least one of the voice data and the motion data described above. Then, the behavior information acquisition unit 1102 acquires the measured data as the behavior information. That is, the behavior information may be information including at least one of the voice data and the motion data.

The estimation unit 120 estimates the activity state of the subject based on the behavior information. Specifically, based on the motion data included in the behavior information, the estimation unit 120 may estimate whether the subject is in the busy state or the free state. For example, in a case where it is estimated from the motion data that the subject moves by running or moves at a frequency of a predetermined number of times or more per unit time, the estimation unit 120 may estimate that the subject is in the busy state. In addition, for example, in a case where it is estimated from the motion data that the subject is stationary for a predetermined time or more or moves at a frequency less than the predetermined number of times per unit time, the estimation unit 120 may estimate that the subject is in the free state.

In addition, based on the voice data included in the behavior information, the estimation unit 120 may estimate whether the subject is in the busy state or the free state. For example, in a case where it is estimated from the voice data that the subject is speaking with a voice of a certain volume or more or speaking at a frequency of a predetermined number of times or more per unit time, the estimation unit 120 may estimate that the subject is in the busy state. In addition, for example, in a case where it is estimated from the voice data that the subject speaks at a frequency less than the predetermined number of times per unit time, the estimation unit 120 may estimate that the subject is in the free state.

In addition, the estimation unit 120 may estimate the activity state of the subject from the conversation content estimated from the voice data. For example, the estimation unit 120 converts voice from voice data into text. That is, the estimation unit 120 may use a voice recognition technology. For example, the estimation unit 120 specifies which phoneme the input voice is by using an acoustic model. Then, the estimation unit 120 specifies a word and a sentence from the specified phoneme by using a language model. At this time, the acoustic model and the language model are machine learning models generated by using machine learning such as deep learning. Note that the present invention is not limited to this example, and an existing voice recognition technology can be used.

Then, the estimation unit 120 estimates what the subject is performing from the information of the text converted from the voice data. For example, the estimation unit 120 extracts a keyword from the information of the text converted from the voice data. Then, the estimation unit 120 estimates, based on the extracted keyword, whether the subject is chatting or responding to a task. Then, in a case where the subject is chatting, the estimation unit 120 may estimate that the subject is in the free state. In addition, in a case where the subject is responding to a task, the estimation unit 120 may estimate that the subject is in the busy state.

Note that various methods can be applied as the method of estimating the activity state. For example, the method of estimating the activity state may be a method based on various machine learning models such as deep learning. The machine learning model in this case is, for example, a model in which a relationship between the behavior information and the activity state is learned in advance. The estimation unit 120 may input the acquired behavior information to the machine learning model and estimate, as the activity state of the subject, the information obtained as an output. At this time, the estimation unit 120 may further estimate the activity state by using the position information. For example, the estimation unit 120 inputs the acquired behavior information and position information to the machine learning model. Then, the estimation unit 120 estimates, as the activity state of the subject, the information obtained as the output. The machine learning model in this case is a model in which a relationship between the behavior information and the position information, and the activity state is learned in advance.

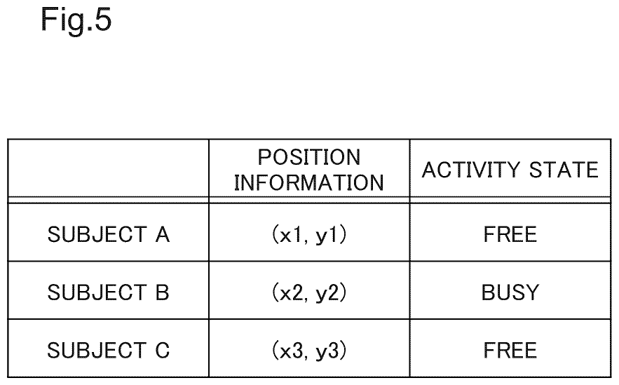

The output control unit 130 outputs the subject information. Specifically, the output control unit 130 associates the position information of the same subject with the activity state. At this time, for example, the output control unit 130 may associate the position information of the same subject with the activity state based on the identification information of the subject. Then, the output control unit 130 outputs, as the subject information, information in which the position information and the activity state are associated with each other for each subject, to the display device of the instruction system 10 that can be visually recognized by the operator of the instruction room. FIG. 5 is a diagram illustrating an example of the subject information. As illustrated in FIG. 5, the subject information includes information in which the position information and the estimated activity state are associated with each other for each subject. For example, a record in the first line indicates that a subject A exists at coordinates (x1, y1) and is in the free state. In this manner, the output control unit 130 may output the subject information in a text format and a table format.

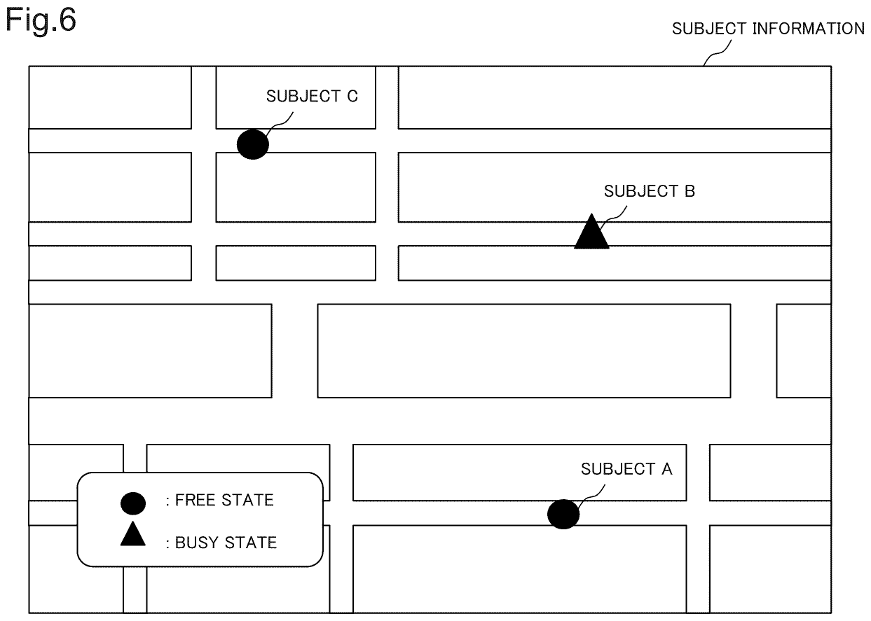

An example of the subject information is not limited to this example. FIG. 6 is a diagram illustrating another example of the subject information. In the example of FIG. 6, a marker is superimposed on the position where the subject is on the map, based on the position information. Then, the markers are shown in different modes depending on the activity state. Specifically, the marker of the subject A is indicated by a circle, and the marker of a subject B is indicated by a triangle. For example, the circle indicates the free state, and the triangle indicates the busy state. That is, it is indicated that the subject A is in the free state and the subject B is in the busy state. In this manner, the output control unit 130 may output, as the subject information, the information in which the position information and the activity state are shown on the map in association with each other. In addition, the output control unit 130 may display the information of different modes depending on the activity state at the position of the subject on the map. For example, the output control unit 130 may change the shape, size, color, contour thickness, and the like of the mark according to the activity state.

### [Operation Example of State Estimation Device 100]

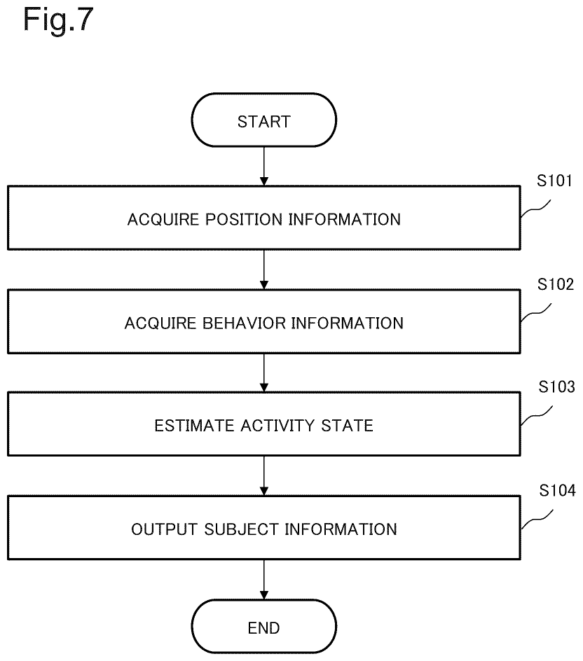

Next, an example of the operation of the state estimation device 100 will be described with reference to FIG. 7.

FIG. 7 is a flowchart illustrating an example of the operation of the state estimation device 100. First, the position information acquisition unit 1101 acquires position information of each of a plurality of subjects (S101). The behavior information acquisition unit 1102 acquires behavior information of each of the plurality of subjects (S102). The estimation unit 120 estimates the activity state based on the behavior information (S103). Then, the output control unit 130 outputs subject information (S104).

In this manner, the state estimation device 100 according to the second example embodiment acquires the position information of the plurality of subjects and the behavior information that is the information relating to the behaviors measured for the subjects. In addition, the state estimation device 100 estimates the activity state of each of the subjects based on the behavior information. Then, the state estimation device 100 outputs the subject information that is information showing the position information and the activity state for each subject. For example, it is assumed that an operator of the instruction room issues an instruction to the subject when an event such as an incident or an accident has occurred. The state estimation device 100 can output the position information and activity states of the plurality of subjects. Accordingly, for example, the operator of the instruction room can grasp the subject who can respond to the instruction by checking the position information and the activity state of each of the subjects. Therefore, for example, the operator of the instruction room can send an instruction to a subject who can respond to the instruction, so that the occurring event can be handled more quickly. Therefore, the state estimation device 100 can support the suitable issuance of the instruction to the subject.

In addition, in the second example embodiment, the behavior information may include at least one of motion data and voice data of the subject. Then, the state estimation device 100 may estimate each activity state of the subject from at least one of the motion data and the voice data. Accordingly, the state estimation device 100 can estimate the activity state from the operation, statement, or the like of the subject.

In addition, the state estimation device 100 according to the second example embodiment may output, as the subject information, information in which the position information and the activity state are shown on the map in association with each other. At this time, the state estimation device 100 may display information of different modes depending on the activity state at the position of the subject shown on the map. Accordingly, the operator of the instruction room can intuitively grasp the activity state of the subject. Therefore, the operator of the instruction room can grasp the subject who can respond to the instruction more quickly.

### [First Modification]

A timing at which each processing of the state estimation device 100 is performed can be variously considered. For example, the processing of S101 to S104 may be performed at regular intervals. In addition, the processing of S101 to S104 may be performed in response to a request from the instruction system 10 (that is, a request from the operator of the instruction room).

It is assumed that the instruction system 10 receives a notification in a case where an event such as an incident or an accident has occurred. The state estimation device 100 may perform each processing in response to the notification. For example, in a case where the notification is made, the estimation unit 120 acquires the position information of the notifier from the instruction system 10. For example, it is assumed that the notifier makes the notification by using a portable terminal. The position information of the notifier may be position information transmitted from the portable terminal, or may be position information of a base station connected when this notification is made. The estimation unit 120 specifies a subject existing in a predetermined range from the position information of the notifier. Then, the estimation unit 120 estimates the activity state of the specified subject.

In this manner, in a case where the notification is made, the estimation unit 120 may estimate the activity state of the subject positioned in the predetermined range.

### [Second Modification]

The activity state may not be information indicating any one of two types of states which are the busy state and the free state. The activity state may be information indicating any one of three or more types of states including a different state in addition to the busy state and the free state.

In addition, for example, a plurality of levels may be set in the busy state. For example, the busy state of level 1 may indicate being engaged, and the busy state of level 2 may indicate being engaged but available to respond to an emergency instruction. In this case, for example, the estimation unit 120 estimates, based on the behavior information, whether the subject is in the busy state of level 1, the busy state of level 2, or the free state. At this time, the estimation unit 120 may input the behavior information to the machine learning model and estimate, from the information output by the machine learning model, which state the subject is in. The machine learning model is, for example, a model in which a relationship between the behavior information and the activity state including the busy state of level 1, the busy state of level 2, and the free state is learned in advance.

### Third Example Embodiment

Next, a state estimation device according to a third example embodiment will be described. In the third example embodiment, a further example of the information output by the state estimation device will be described. Note that description of contents overlapping with the contents described in the first and second example embodiments will be partially omitted.

### [Details of State Estimation Device 101]

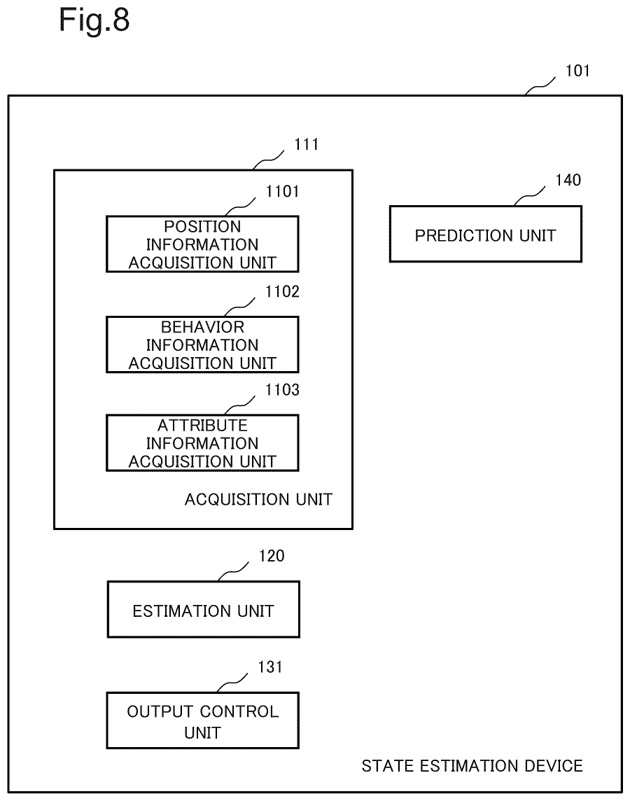

FIG. 8 is a block diagram illustrating an example of a functional configuration of a state estimation device 101. In the present example embodiment, the state estimation device 101 is present instead of the state estimation device 100 illustrated in FIG. 3, for example. That is, the state estimation device 101 can communicate with the instruction system 10, the communication terminal 200, and the sensor 300.

As illustrated in FIG. 8, the state estimation device 101 includes an acquisition unit 111, the estimation unit 120, an output control unit 131, and a prediction unit 140. The state estimation device 101 may perform processing described below in addition to the processing of the state estimation device 100.

The acquisition unit 111 includes the position information acquisition unit 1101, the behavior information acquisition unit 1102, and an attribute information acquisition unit 1103. The attribute information acquisition unit 1103 acquires attribute information. The attribute information is information indicating the attribute of the subject. The attribute of the subject is, for example, gender, age, affiliation, and history. The attribute information may be, for example, information in which the identification information of the subject is associated with an attribute. That is, the attribute information may be information indicating an attribute for each subject.

The attribute information is stored in advance in, for example, a storage device (not illustrated) included in the state estimation device 101 or an external device communicable with the state estimation device 101. In this case, the attribute information acquisition unit 1103 may acquire the attribute information of the subject of which the activity state is estimated by the estimation unit 120, from the device in which the attribute information is stored. In addition, in a case where the attribute information is stored in the communication terminal 200, the attribute information acquisition unit 1103 may acquire the attribute information from the communication terminal 200.

The attribute information is one of indices for determining whether it is possible to respond to with an instruction. For example, it is assumed that an incident occurs and a suspect of the incident needs to be subjected to a physical examination. In this case, if the suspect is a female, a police officer who performs the physical examination is preferably a female. In this regard, in a case where the content of the instruction is a request for reinforcement of personnel for performing a physical examination, it is conceivable that the operator of the instruction room considers the gender of the subject.

In this manner, the attribute information acquisition unit 1103 may acquire, for example, attribute information indicating an attribute including gender.

The prediction unit 140 predicts free time of the subject. Specifically, in a case where the subject is in the busy state, the prediction unit 140 predicts the time until the subject enters the free state. For example, the prediction unit 140 may predict the free time of the subject by a method based on various machine learning models such as deep learning. The machine learning model in this case is, for example, a model in which a relationship between the behavior information or the behavior information and the position information, and the free time is learned in advance. For example, the prediction unit 140 may input the acquired behavior information and position information to the machine learning model and predict, as the free time of the subject, the information obtained as the output.

In addition, the prediction unit 140 may predict the free time based on schedule information of the subject. The schedule information is information indicating an action schedule of the subject. For example, the schedule information includes an action content planned to be performed by the subject and a time for performing the action content. The schedule information is stored in, for example, a storage device (not illustrated) included in the state estimation device 101 or an external device communicable with the state estimation device 101. The prediction unit 140 may refer to the schedule information of the subject and predict, as the free time, the time until the end of the action planned to be performed by the subject.

In this manner, the prediction unit 140 predicts the free time of the subject. The prediction unit 140 is an example of the prediction means.

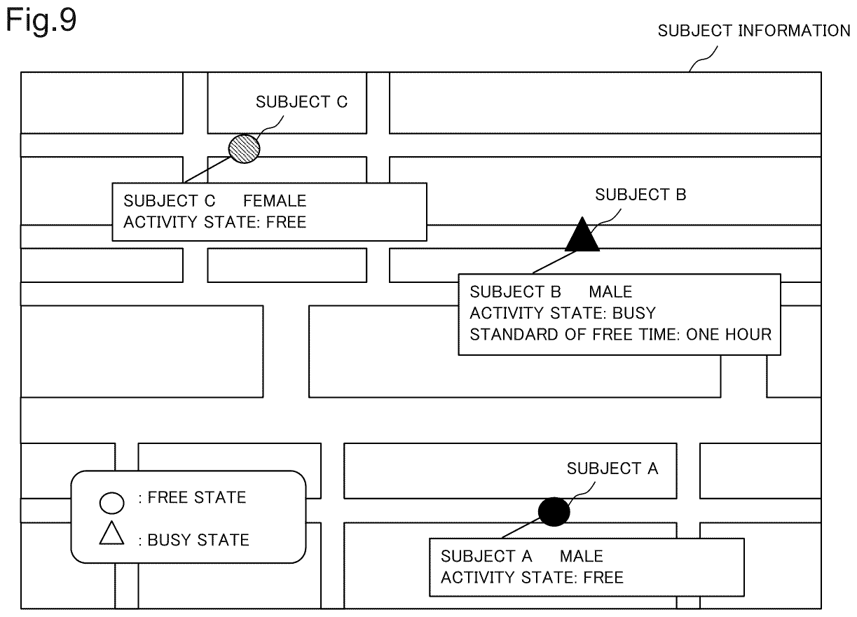

The output control unit 131 outputs the subject information. FIG. 9 is a diagram illustrating an example of the subject information. In the example of FIG. 9, similarly to FIG. 6, a marker is superimposed on the map. The marker indicates a position where the subject is. Furthermore, in the example of FIG. 9, information relating to the subject is associated with the marker. For example, near the marker indicating the subject A, it is indicated that the marker indicates the subject A, that the subject A is male, and that the activity state of the subject A is the free state. In this manner, the output control unit 131 may output the subject information in which the position information, the activity state, and the attribute information are shown for each subject.

In addition, in the example of FIG. 9, it is illustrated that the subject B is male, the activity state of the subject B is the busy state, and the standard of the free time is one hour. In this manner, the output control unit 131 may output the subject information including the information indicating the free time for each subject.

Furthermore, in the example of FIG. 9, the subject A is indicated by a filled circle marker, while the subject C is indicated by a hatched circle marker. In this example, the filled circle marker indicates a male and the hatched circle marker indicates a female. In this manner, the output control unit 131 may display information of different modes depending on the attribute of the subject at the position of the subject shown on the map.

### [Operation Example of State Estimation Device 101]

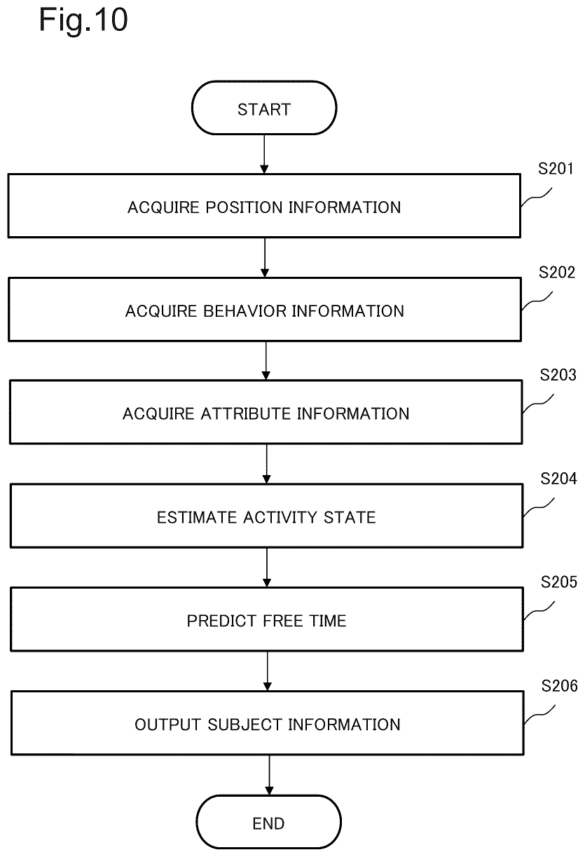

Next, an example of the operation of the state estimation device 101 will be described with reference to FIG. 10.

FIG. 10 is a flowchart illustrating an example of the operation of the state estimation device 101. Since the processing of S201 and S202 is similar to the processing of S101 and S102 of FIG. 7, the description thereof is omitted.

The attribute information acquisition unit 1103 acquires attribute information (S203). At this time, the attribute information acquisition unit 1103 may acquire the attribute information of the subject from which at least one of the position information and the behavior information has been acquired. Then, the estimation unit 120 estimates the activity state of each subject based on the behavior information (S204).

In addition, the prediction unit 140 predicts the free time of the subject (S205). At this time, the prediction unit 140 may predict the free time of the subject of which the activity state is estimated to be the busy state. Then, the output control unit 131 outputs the subject information (S206). At this time, the output control unit 131 may output the subject information including the attribute information and the information indicating the free time in addition to the position information and the activity state of the subject.

In this manner, the state estimation device 101 according to the third example embodiment may acquire the attribute information that is the information showing the attribute including the gender of the subject, and output the subject information in which the position information, the activity state, and the attribute information are shown for each subject. For example, it is assumed that the content of the instruction is a request for reinforcement of personnel for performing a physical examination of the suspect. In this case, the gender of the police officer who performs the physical examination is preferably considered according to the gender of the suspect. On the other hand, the operator of the instruction room can also grasp the attribute of the subject. Therefore, the operator of the instruction room can notify the instruction in consideration of the gender of the subject. That is, the state estimation device 101 can support the suitable issuance of the instruction to the subject.

In addition, the state estimation device 101 according to the third example embodiment may predict the free time of the subject and output the subject information including information indicating the free time for each subject. Accordingly, the operator of the instruction room can grasp, for example, the time until the subject enters the free state. Therefore, for example, the operator of the instruction room can notify the subject of an instruction to respond as soon as the state becomes the free state.

### Fourth Example Embodiment

Next, a state estimation device according to a fourth example embodiment will be described. In the fourth example embodiment, an example of a further function of the state estimation device will be described. Note that description of contents overlapping with the contents described in the first, second, and third example embodiments will be partially omitted.

### [Details of State Estimation Device 102]

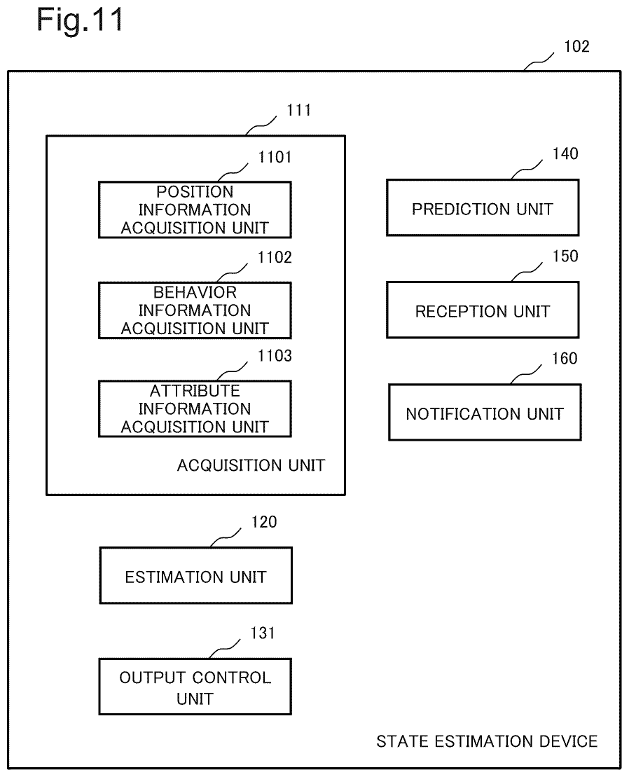

FIG. 11 is a block diagram illustrating an example of a functional configuration of a state estimation device 102. In the present example embodiment, the state estimation device 102 is present instead of the state estimation device 100 illustrated in FIG. 3, for example. That is, the state estimation device 102 can communicate with the instruction system 10, the communication terminal 200, and the sensor 300.

As illustrated in FIG. 11, the state estimation device 102 includes the acquisition unit 111, the estimation unit 120, the output control unit 131, the prediction unit 140, the reception unit 150, and a notification unit 160. The state estimation device 102 may perform processing described below in addition to the processing of the state estimation device 100 and the state estimation device 101.

The reception unit 150 receives an input from the subject. More specifically, the reception unit 150 receives, from the communication terminal 200, information input by the subject. An example of the received information is a dummy instruction request. The dummy instruction request is information for notifying a dummy instruction.

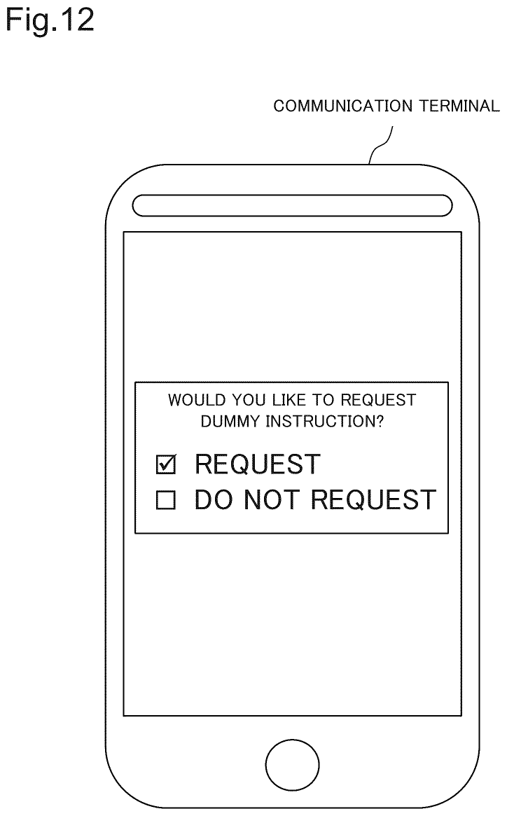

The subject may have made an unnecessary or non-urgent response. For example, it is assumed that the subject is a police officer. The police officer may receive, from a resident, unnecessary or non-urgent chatter, consultation that the police is not to respond to, or the like. In such a case, the police officer inputs the dummy instruction request by using the communication terminal 200. FIG. 12 is a diagram illustrating a display example of the communication terminal 200. In the example of FIG. 12, information for asking whether there is a request for a dummy instruction is displayed on the display of the communication terminal 200. In this manner, the communication terminal 200 may display the information for asking whether there is a request for a dummy instruction. In this example, in a case where the subject selects “request”, the communication terminal 200 transmits the dummy instruction request to the state estimation device 102. The reception unit 150 receives, for example, the dummy instruction request transmitted from the communication terminal 200.

In this manner, the reception unit 150 receives the dummy instruction request from the subject. The reception unit 150 is an example of the reception means.

The notification unit 160 notifies an instruction. The notification unit 160 is an example of the notification means. For example, the notification unit 160 may notify the communication terminal 200 of the subject of the instruction by the operation of the operator of the instruction room. The instruction notified in this manner may be, for example, information input by an operator of the instruction room. For example, the instruction includes information relating to an occurring event, information indicating an action to be performed by the subject, or the like. At this time, the notification unit 160 may notify the subject selected by the operator of the instruction room of the instruction. In addition, the notification unit 160 may notify the subject of which the activity state is the free state of the instruction. That is, the notification unit 160 may notify the subject in the free state of the instruction even if the operator of the instruction room does not select the subject.

Furthermore, the notification unit 160 may notify a dummy instruction. Specifically, in a case where the reception unit 150 receives a dummy instruction request, the notification unit 160 may notify the communication terminal 200 of the subject who has made the dummy instruction request of the dummy instruction. That is, the notification unit 160 notifies the subject who has made the dummy instruction request of the dummy instruction.

The notified instruction may be output, for example, on a display of the communication terminal 200 or may be output by voice in a speaker of the communication terminal 200.

Note that the notification unit 160 may notify a device other than the communication terminal 200 of the instruction. For example, the notification unit 160 may notify a device such as a wireless device possessed by the subject of the instruction.

### [Operation Example of State Estimation Device 102]

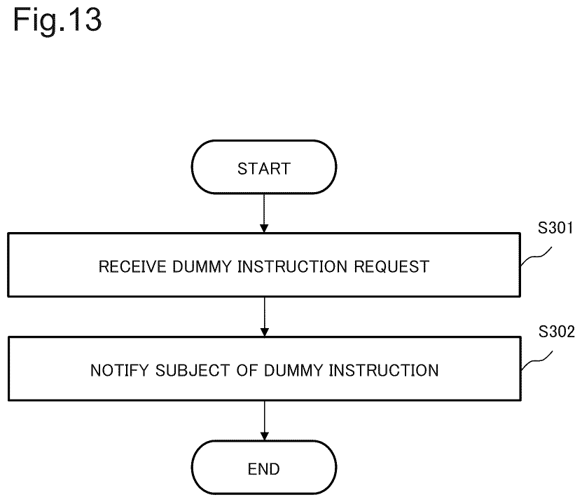

Next, an example of the operation of the state estimation device 102 will be described with reference to FIG. 13.

FIG. 13 is a flowchart illustrating an example of the operation of the state estimation device 102. In the present operation example, processing when the state estimation device 102 notifies a dummy instruction will be described.

The reception unit 150 receives the dummy instruction request from the communication terminal 200 of the subject (S301). Then, the notification unit 160 notifies the subject who has made the dummy instruction request of the dummy instruction (S302).

As described above, the state estimation device 102 according to the fourth example embodiment may receive the dummy instruction request from the subject and notify the subject who has made the dummy instruction request of the dummy instruction. For example, there is a case where the subject performs an unnecessary or non-urgent response. At this time, since the subject can receive the dummy instruction, there is a possibility that the subject can interrupt the unnecessary or non-urgent response due to the dummy instruction. That is, the state estimation device 102 can support the subject who desires to interrupt the unnecessary or non-urgent response.

### [Third Modification]

The reception unit 150 may further receive an input of an activity state from the subject. Specifically, the subject inputs, to the communication terminal 200, information indicating whether the subject is in the busy state or the free state. The communication terminal 200 transmits the input information to the state estimation device 102. The reception unit 150 receives the input information from the state estimation device 102.

At this time, the estimation unit 120 may estimate the activity state of the subject based on the information received by the reception unit 150. For example, it is assumed that information indicating that the subject is in the busy state is received by the reception unit 150. At this time, the estimation unit 120 may estimate that the subject is in the busy state.

In this manner, the reception unit 150 may receive an input including information indicating whether it is the busy state. In addition, the estimation unit 120 may estimate the information included in the input as the activity state of the subject who has made the input.

Note that the communication terminal 200 may be mounted on a vehicle. For example, in a case where the subject is a police officer, the communication terminal 200 is mounted on the patrol car. For example, when the police officer who rides on the patrol car is responding to another task, the police officer inputs, to the communication terminal 200 mounted on the patrol car, information indicating that the police officer is responding. The communication terminal 200 transmits, to the state estimation device 102, the information indicating that the police officer is responding. When the reception unit 150 receives the information indicating that the police officer is responding, the estimation unit 120 estimates the activity state of the police officer as the busy state.

### <Configuration Example of Hardware of State Estimation Device>

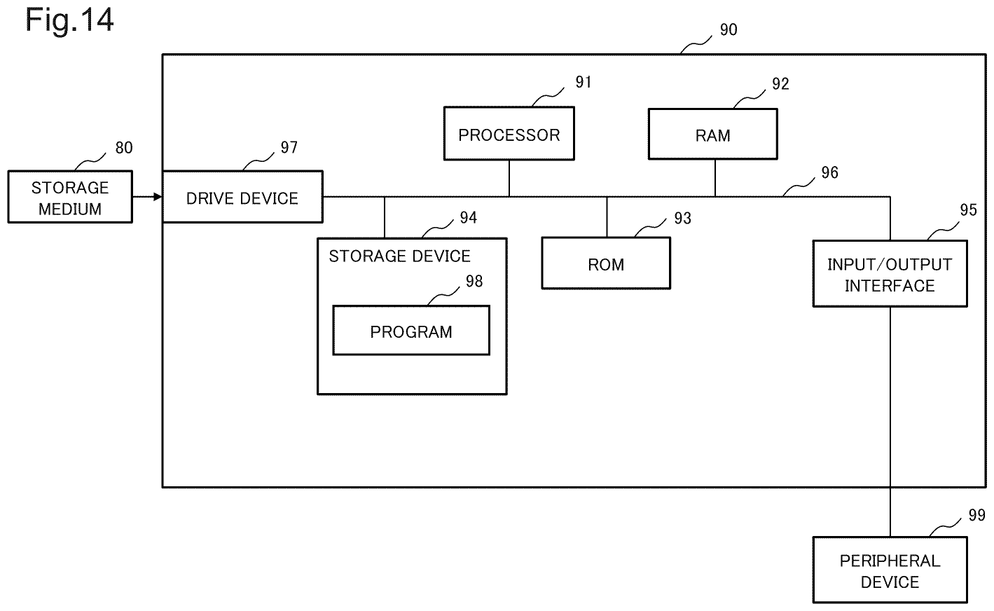

Hardware constituting the state estimation devices of the first, second, third, and fourth example embodiments described above will be described. FIG. 14 is a block diagram illustrating an example of a hardware configuration of a computer device which achieves the state estimation device according to each embodiment. In the computer device 90, the state estimation device and the state estimation method described in each example embodiment and each modification are achieved.

As illustrated in FIG. 14, the computer device 90 includes a processor 91, a random access memory (RAM) 92, a read only memory (ROM) 93, a storage device 94, an input/output interface 95, a bus 96, and a drive device 97. Note that the state estimation device may be achieved by a plurality of electric circuits.

The storage device 94 stores a program (computer program) 98. The processor 91 executes the program 98 of the present state estimation device by using the RAM 92. Specifically, for example, the program 98 includes a program that causes a computer to execute the processing illustrated in FIGS. 2, 7, 10, and 13. When the processor 91 executes the program 98, the functions of the components of the state estimation device are implemented. The program 98 may be stored in the ROM 93. In addition, the program 98 may be recorded in a storage medium 80 and read using the drive device 97, or may be transmitted from an external device (not illustrated) to the computer device 90 via a network (not illustrated).

The input/output interface 95 exchanges data with peripheral devices (such as a keyboard, a mouse, and a display device) 99. The input/output interface 95 functions as a means for acquiring or outputting data. The bus 96 connects the components.

Note that there are various modifications of the method for achieving the state estimation device. For example, the state estimation device can be achieved as a dedicated device. In addition, the state estimation device can be achieved based on a combination of a plurality of devices.

A processing method for causing the storage medium to record the program for achieving each component in the functions of each example embodiment, reading the program recorded in the storage medium as a code, and executing the program in a computer are also included in the scope of each example embodiment. That is, a computer-readable storage medium is also included in the scope of each example embodiment. The storage medium in which the above-described program is recorded and the program itself are also included in each example embodiment.

The storage medium is, for example, a floppy (registered trademark) disk, a hard disk, an optical disk, a magneto-optical disk, a compact disc (CD)-ROM, a magnetic tape, a nonvolatile memory card, or a ROM, but is not limited to this example. The program recorded in the storage medium is not limited to a program which executes processing alone, and a program which operates on an operating system (OS) to execute processing in cooperation with other software and functions of an extension board is also included in the scope of each example embodiment.

While the invention has been particularly shown and described with reference to exemplary example embodiments thereof, the invention is not limited to these example embodiments. It will be understood by those of ordinary skill in the art that various changes in form and details may be made therein without departing from the spirit and scope of the present invention as defined by the claims.

The above-described example embodiments and modifications can be appropriately combined.

Some or all of the above-described example embodiments may be described as the following supplementary notes, but are not limited to the following.

### <Supplementary Note>

### [Supplementary Note 1]

A state estimation device including:
an acquisition means for acquiring position information of a plurality of subjects and behavior information that is information relating to behaviors measured with respect to the subjects;
an estimation means for estimating an activity state of each of the subjects based on the behavior information; and
an output control means for outputting subject information that is information showing the position information and the activity state for each of the subjects.

### [Supplementary Note 2]

The state estimation device according to supplementary note 1, wherein
the behavior information includes at least one of motion data and voice data of the subject, and
the estimation means estimates the activity state of each of the subjects from at least one of the motion data and the voice data.

### [Supplementary Note 3]

The state estimation device according to supplementary note 1 or 2, wherein
the output control means outputs, as the subject information, information in which the position information and the activity state are shown on a map in association with each other.

### [Supplementary Note 4]

The state estimation device according to supplementary note 3, wherein
the output control means displays information of different modes depending on the activity state at a position of the subject shown on the map.

### [Supplementary Note 5]

The state estimation device according to any one of supplementary notes 1 to 4, wherein
the acquisition means acquires attribute information that is information showing an attribute including a gender of the subject, and
the output control means outputs the subject information in which the position information, the activity state, and the attribute information are shown for each of the subjects.

### [Supplementary Note 6]

The state estimation device according to any one of supplementary notes 1 to 5, further including:
a prediction means for predicting free time of the subject, wherein
the subject information including information indicating the free time for each of the subjects is output.

### [Supplementary Note 7]

The state estimation device according to any one of supplementary notes 1 to 6, further including:
a notification means for notifying, of an instruction, the subject that is positioned in a predetermined range and has the activity state of a free state.

### [Supplementary Note 8]

The state estimation device according to supplementary note 7, further including:
a reception means for receiving a dummy instruction request from the subject, wherein
the notification means notifies, of a dummy instruction, the subject that has made the dummy instruction request.

### [Supplementary Note 9]

The state estimation device according to supplementary note 8, wherein
the reception means receives an input including information indicating whether the activity state is a busy state, and
the estimation means estimates the information included in the input as the activity state of the subject that has made the input.

### [Supplementary Note 10]

The state estimation device according to any one of supplementary notes 1 to 9, wherein
the estimation means estimates the activity state of the subject positioned in a predetermined range in a case where a notification is made.

### [Supplementary Note 11]

The state estimation device according to supplementary note 5, wherein
the output control means displays information of different modes depending on the attribute information of the subject at the position of the subject shown on the map.

### [Supplementary Note 12]

The state estimation device according to any one of supplementary notes 1 to 11, wherein
the subject is at least one of a police officer, a fire brigade, and an ambulance team.

### [Supplementary Note 13]

A state estimation method including:
acquiring position information of a plurality of subjects and behavior information that is information relating to behaviors measured with respect to the subjects;
estimating an activity state of each of the subjects based on the behavior information; and
outputting subject information that is information showing the position information and the activity state for each of the subjects.

### [Supplementary Note 14]

A computer-readable storage medium having stored therein a program that causes a computer to execute:
a process of acquiring position information of a plurality of subjects and behavior information that is information relating to behaviors measured with respect to the subjects;
a process of estimating an activity state of each of the subjects based on the behavior information; and
a process of outputting subject information that is information showing the position information and the activity state for each of the subjects.

### REFERENCE SIGNS LIST

10 instruction system
100, 101, 102 state estimation device
110 acquisition unit
120 estimation unit
130, 131 output control unit
140 prediction unit
150 reception unit
160 notification unit
200 communication terminal
300 sensor
1101 position information acquisition unit
1102 behavior information acquisition unit
1103 attribute information acquisition unit

What is claimed is:

1. A state estimation device comprising:
at least one memory storing a computer program; and
at least one processor configured to execute the computer program to
acquire position information of a plurality of subjects and behavior information that is information relating to behaviors measured with respect to the subjects;
estimate an activity state of each of the subjects based on the behavior information; and
output subject information that is information showing the position information and the activity state for each of the subjects.

2. The state estimation device according to claim 1, wherein
the behavior information includes at least one of motion data and voice data of the subject, and
the processor is configured to execute the computer program to
estimate the activity state of each of the subjects from at least one of the motion data and the voice data.

3. The state estimation device according to claim 1, wherein the processor is configured to execute the computer program to
output, as the subject information, information in which the position information and the activity state are shown on a map in association with each other.

4. The state estimation device according to claim 3, wherein the processor is configured to execute the computer program to
display information of different modes depending on the activity state at a position of the subject shown on the map.

5. The state estimation device according to claim 1, wherein the processor is configured to execute the computer program to
acquire attribute information that is information showing an attribute including a gender of the subject, and
output the subject information in which the position information, the activity state, and the attribute information are shown for each of the subjects.

6. The state estimation device according to claim 1, wherein the processor is configured to execute the computer program to
predict free time of the subject, and
the subject information including information indicating the free time for each of the subjects is output.

7. The state estimation device according to claim 1, wherein the processor is configured to execute the computer program to
notify, of an instruction, the subject that is positioned in a predetermined range and has the activity state of a free state.

8. The state estimation device according to claim 7, wherein the processor is configured to execute the computer program to
receive a dummy instruction request from the subject, and
notify, of a dummy instruction, the subject that has made the dummy instruction request.

9. The state estimation device according to claim 8, wherein the processor is configured to execute the computer program to
receive an input including information indicating whether the activity state is a busy state, and
estimate the information included in the input as the activity state of the subject that has made the input.

10. The state estimation device according to claim 1, wherein the processor is configured to execute the computer program to
estimate the activity state of the subject positioned in a predetermined range in a case where a notification is made.

11. The state estimation device according to claim 5, wherein the processor is configured to execute the computer program to
display information of different modes depending on the attribute information of the subject at the position of the subject shown on the map.

12. The state estimation device according to claim 1, wherein
the subject is at least one of a police officer, a fire brigade, and an ambulance team.

13. A state estimation method comprising:
acquiring position information of a plurality of subjects and behavior information that is information relating to behaviors measured with respect to the subjects;
estimating an activity state of each of the subjects based on the behavior information; and
outputting subject information that is information showing the position information and the activity state for each of the subjects.

14. A non-transitory computer-readable storage medium having stored therein a program that causes a computer to execute:
a process of acquiring position information of a plurality of subjects and behavior information that is information relating to behaviors measured with respect to the subjects;
a process of estimating an activity state of each of the subjects based on the behavior information; and
a process of outputting subject information that is information showing the position information and the activity state for each of the subjects.
